(19) United States
(12) Patent Application Publication
(10) Pub. No.: US 2012/0124583 A1
(43) Pub. Date: May 17, 2012

(54) APPARATUS AND METHOD FOR PARALLEL PROCESSING FLOW BASED DATA

(75) Inventors: Dong Myoung BAEK, Daejeon (KR); Bhum Cheol LEE, Daejeon (KR); Kang Il CHOI, Daejeon (KR); Sang Yoon OH, Daejeon (KR)

(73) Assignee: Electronics and Telecommunications Research Institute, Daejeon (KR)

(21) Appl. No.: 13/297,607

(22) Filed: Nov. 16, 2011

(30) Foreign Application Priority Data
Nov. 16, 2010 (KR) 10-2010-0113800

(51) Int. Cl. G06F 9/46

(52) U.S. Cl. 718/100

(57) ABSTRACT

Disclosed is an apparatus for parallel processing flow based data that may generate a first flow and a second flow based on data classified into lower layer information and upper layer information, may determine whether processing of the lower layer information or the upper layer information is required by analyzing the first flow or the second flow, and may process and output the lower layer information or the upper layer information using a flow unit based on the determination result.

### CROSS-REFERENCE TO RELATED APPLICATION

This application claims the priority benefit of Korean Patent Application No. 10-2010-0113800, filed on Nov. 16, 2010, in the Korean Intellectual Property Office, the disclosure of which is incorporated herein by reference.

### BACKGROUND

1. Field of the Invention

Embodiments of the present invention relate to an apparatus and method for parallel processing data in a multiprocessor.

2. Description of the Related Art

Currently, various methods for processing a large amount of data have been studied and developed. The processing performance may become an issue to process data using multiple layers, and a use of a multiprocessor may be required to enhance the processing performance.

The multiprocessor may be advantageous in aspects of data processing performance and power consumption, and may be installed with various programs to configure functions. Accordingly, the multiprocessor is being increasingly widely used for terminals, electronic appliances, communications, broadcastings, and the like.

In general, a processing rate of the multiprocessor is associated with a parallel processing rate. When the parallel processing rate is low, the overall multiprocessor processing rate may not increase and may become saturated even though the number of individual processors included in the multiprocessor increases.

To linearly increase the parallel processing rate of the multiprocessor with respect to the number of individual processors, a portion to be parallel processed may need to be significantly greater than a portion to be serial processed. Through this, it is possible to enhance the overall processing rate.

In general, a data processing system may more use the multiprocessor to enhance the multilayer processing performance. When performing parallel processing, sequences of processed data flows may need to be maintained.

For example, the data processing system may maintain a flow sequence and enhance the processing performance by classifying an input data flow in detail and by assigning the same flow to the same processor core when the predetermined processor core is processing the corresponding flow.

In the above case, the data processing system may need to process multilayered data having different attributes using a multiprocessor that has a single array. Thus, it may be difficult to enhance the processing performance in a scalable manner, and to use the multiprocessor with a processor array having a different structure.

To process multilayered data, the data processing system may group and thereby process a plurality of layers of the data, thereby enhancing a data processing rate.

For example, the data processing system may classify seven layers of input data into two or three groups, and may maintain the performance with respect to layers 2 to 4 and secure the flexibility with respect to layer 7, thereby enhancing a data processing rate.

Through the above method, the data processing system may enhance the processing performance in layer 7 and may perform processing in layers 2 to 4, regardless of layer 7. However, when performing multilayer processing, the integrated processing performance of layers 2 to 7 may be degraded due to the difference between the performance of layers 2 to 4 and the performance of layer 7.

### SUMMARY

According to an aspect of the present invention, there is provided an apparatus for parallel processing flow based data, the apparatus including: an input unit to receive data; a data classifier to classify the data into lower layer information and upper layer information; a flow generator to generate a first flow and a second flow using the lower layer information or the upper layer information; a determining unit to determine whether processing of the lower layer information or the upper layer information is required by analyzing the first flow or the second flow; a processing unit to process the lower layer information or the upper layer information using a flow unit, based on the determination result; and an output unit to output a processed flow.

The flow generator may generate the first flow based on the lower layer information.

The parallel processing apparatus may further include a flow classifier to classify the first flow using a portion of or all of the lower layer information or the upper layer information.

The determining unit may analyze the classified first flow to determine whether processing of the upper layer information is required.

When processing of the upper layer information is not required as the determination result, the processing unit may process the lower layer information based on a first flow unit, and the output unit may output the processed first flow.

When processing of the upper layer information is required as the determination result, the flow generator may generate the second flow based on the upper layer information, and the processing unit may process the upper layer information based on a second flow unit.

The determining unit may analyze the processed second flow to determine whether processing of the lower layer information is required.

When processing of the lower layer information is not required as the determination result, the output unit may output the processed second flow.

When processing of the lower layer information is required as the determination result, the processing unit may process the lower layer information in association with the first flow and the second flow, and the output unit may output the first flow of the lower layer information that is processed in association with the first flow and the second flow.

According to another aspect of the present invention, there is provided a method for parallel processing flow based data, the method including: receiving data; classifying the data into lower layer information and upper layer information; generating a first flow and a second flow using the lower layer information or the upper layer information; determining whether processing of the lower layer information or the upper layer information is required by analyzing the first flow or the second flow; processing the lower layer information or the upper layer information using a flow unit, based on the determination result; and outputting a processed flow.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of an apparatus for parallel processing flow based data according to an embodiment of the present invention;

FIG. 2 is a flowchart illustrating a method for parallel processing flow based data according to an embodiment of the present invention;

FIG. 3 is a diagram illustrating in detail a method for parallel processing flow based data according to an embodiment of the present invention; and

FIG. 4 is a diagram illustrating an implementation example of a method for parallel processing flow based data according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures. However, the present invention is not limited thereto or restricted thereby.

When it is determined detailed description related to a related known function or configuration they may make the purpose of the present invention unnecessarily ambiguous in describing the present invention, the detailed description will be omitted here. Also, terminologies used herein are defined to appropriately describe the exemplary embodiments of the present invention and thus may be changed depending on a user, the intent of an operator, or a custom. Accordingly, the terminologies must be defined based on the following overall description of this specification.

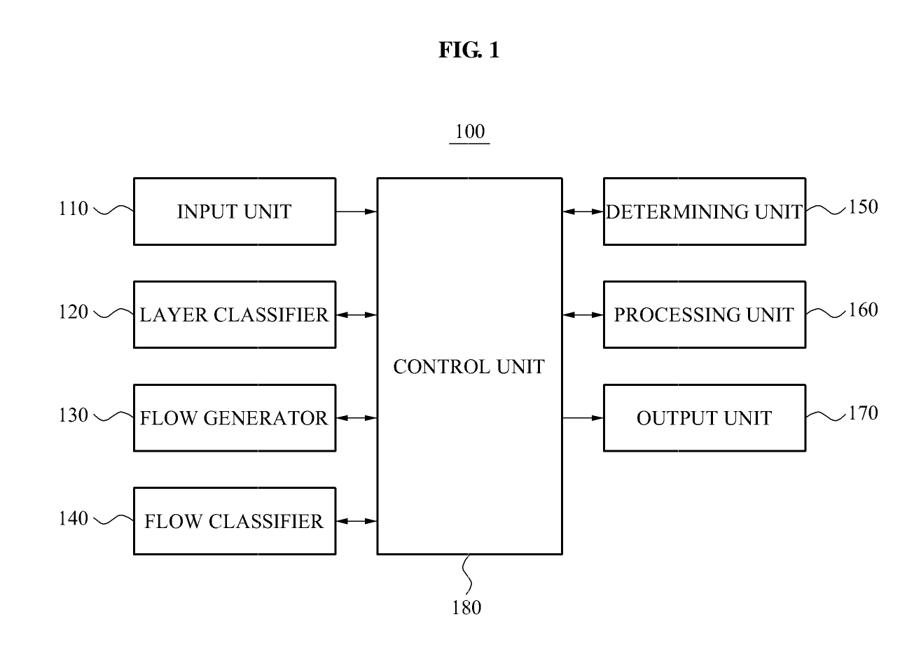

FIG. 1 is a block diagram illustrating a configuration of an apparatus 100 for parallel processing flow based data (hereinafter, referred to as an parallel processing apparatus) according to an embodiment of the present invention.

Referring to FIG. 1, the parallel processing apparatus 100 may include an input unit 110, a layer classifier 120, a flow generator 130, a determining unit 150, a processing unit 160, and an output unit 170.

The parallel processing apparatus 100 according to an embodiment of the present invention may provide a method for parallel processing flow based data that may enhance the multilayer processing performance by classifying data into lower layer information and upper layer information using a multiprocessor including at least one processor, and by classifying each of the lower layer information and the upper layer information based on a flow unit and thereby processing the classified information.

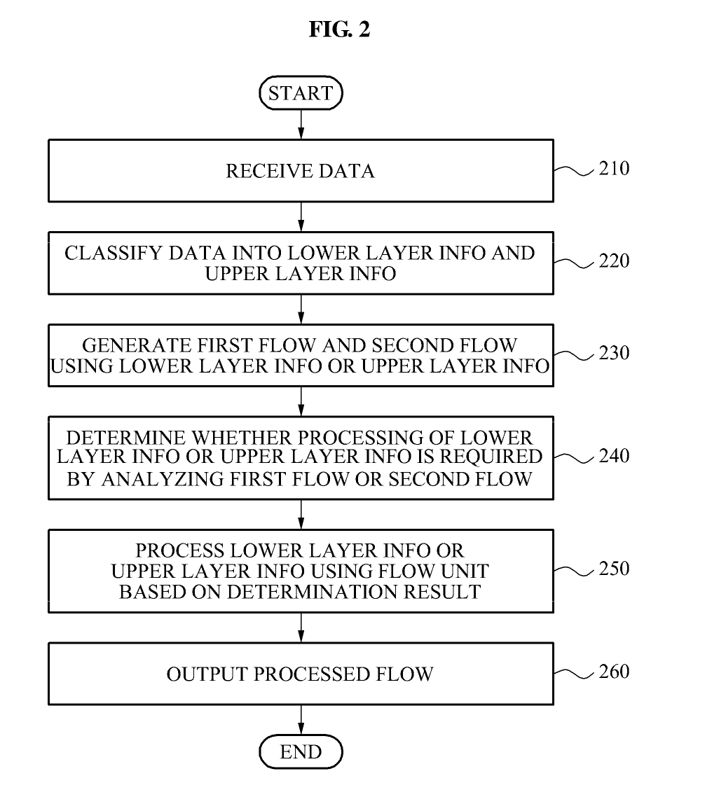

FIG. 2 is a flowchart illustrating a method for parallel processing flow based data according to an embodiment of the present invention.

Referring to FIG. 1, in operation 210, the parallel processing apparatus 100 may receive data using the input unit 110.

In operation 220, the parallel processing apparatus 100 may classify the data into lower layer information and upper layer information using the layer classifier 120.

In operation 230, the flow generator 130 of the parallel processing apparatus 100 may generate a first flow and a second flow using the lower layer information or the upper layer information.

In operation 240, the determining unit 150 of the parallel processing apparatus 100 may determine whether processing of the lower layer information or the upper layer information is required by analyzing the first flow or the second flow.

In operation 250, the processing unit 160 of the parallel processing apparatus 100 may process the lower layer information or the upper layer information using a flow unit, based on the determination result.

In operation 260, the parallel processing apparatus 100 may output a processed flow using the output unit 170.

The parallel processing apparatus 100 according to an aspect of the present invention may control each of modules, for example, the input unit 110, the layer classifier 120, the flow generator 130, the determining unit 150, the processing unit 160, and the output unit 170, using a control unit 180.

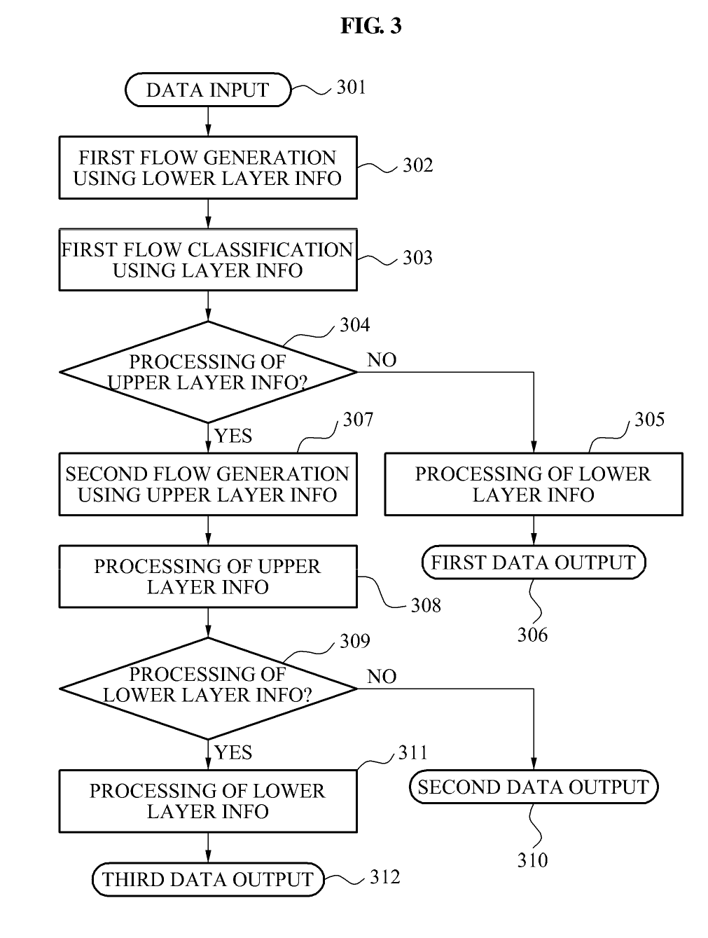

Hereinafter, a method for parallel processing flow based data according to an embodiment of the present invention will be further described with reference to FIG. 3.

FIG. 3 is a diagram illustrating in detail a method for parallel processing flow based data according to an embodiment of the present invention.

Referring to FIG. 3, the parallel processing apparatus 100 may receive data using the input unit 110 in operation 301, and may generate a first flow based on lower layer information using the flow generator 130 in operation 302.

For example, the parallel processing apparatus 100 may receive data of which layer 1 to layer 7 are to be processed.

According to an aspect of the present invention, data may include lower layers of from layer 1 to layer 6, and an upper layer of layer 7, may include lower layers of from layers 2 to 4 and upper layers of from layers 5 to 7, and the like. That is, the data may include lower layers and upper layers that are arbitrarily determined.

In the following, description will be made based on the assumption that the lower layers include layers 2 to 4 and the upper layers include layers 5 to 7.

According to an aspect of the present invention, input data may be data of which layers 2 to 7 are to be processed, and may be data of which layers 2 to 4 are to be processed.

According to an aspect of the present invention, input data may be multilayered processing data of which various layers are to be processed. Thus, when the parallel processing apparatus 100 generates a flow based on lower layer information as above, the performance for processing lower layer information may be enhanced.

In operation 303, a flow classifier 140 of the parallel processing apparatus 100 may classify the first flow using a portion of or all of the lower layer information or the upper layer information.

Since the parallel processing apparatus 100 can accurately classify a flow when using a large amount of flow information, it may be desirable to enhance a classification processing rate.

To enhance a processing rate, the parallel processing apparatus 100 may classify a flow through parallel processing using a multi-core, and may perform parallel processing of lower layer information based on the generated flow.

In operation 304, the determining unit 150 of the data parallel processing apparatus 100 may determine whether processing of the upper layer information is required by analyzing the first flow.

When processing of the upper layer information is not required as the determination result, the parallel processing apparatus 100 may process the lower layer information based on a first flow unit using the processing unit 160 in operation 305, and may output the processed first flow using the output unit 170 in operation 306.

On the contrary, when processing of the upper layer information is required as the determination result, the parallel processing apparatus 100 may generate a second flow based on the upper layer information in operation 307.

According to an aspect of the present invention, the second flow may be the same as the first flow and may also be different from the first flow.

According to an aspect of the present invention, a data field to be processed in lower layer information may be different from a data field to be processed in upper layer information. Thus, a data field required to generate a flow of determining a parallel processing rate may be different with respect to each of a case of the lower layer information and a case of the upper layer information.

To perform parallel processing of the upper layer information, the parallel processing apparatus 100 may regenerate the second flow using the data field of the upper layer information in response to parallel processing of the upper layer information.

In operation 308, the processing unit 160 of the parallel processing apparatus 100 may process the upper layer information based on a second flow unit.

According to an aspect of the present invention, when processing the second flow, the parallel processing apparatus 100 may process data by employing a data parallel processing method using a multi-core processor in order to enhance a data processing rate, and may perform parallel processing of the upper layer information based on the second flow.

In operation 309, the determining unit 150 of the parallel processing apparatus 100 may analyze the processed second flow and thereby determine whether processing of the lower layer information is required.

When processing of the lower layer information is not required as the determination result, the parallel processing apparatus 100 may output the processed second flow using the output unit 170 in operation 310.

On the contrary, when processing of the lower layer information is required as the determination result, the processing unit 160 of the parallel processing apparatus 100 may process the lower layer information in association with the first flow and the second flow in operation 311.

In operation 312, the parallel processing apparatus 100 may output the first flow of the lower layer information that is processed in association with the first flow and the second flow, using the output unit 170. Here, the first flow of the lower layer information may correspond to third data.

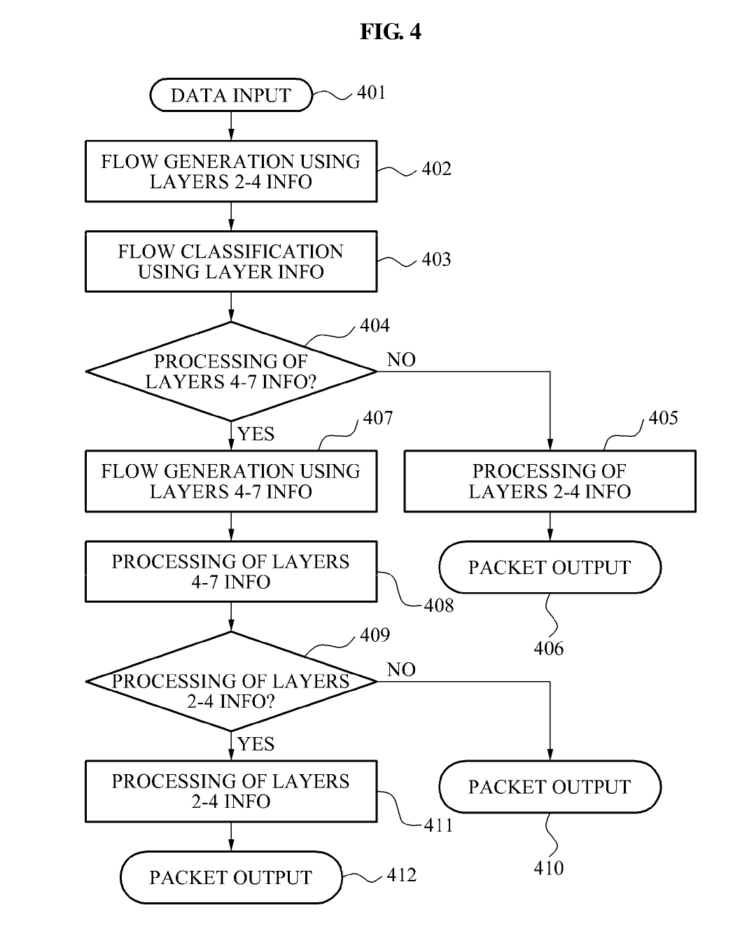

Hereinafter, an implementation example of a method for parallel processing flow based data according to an embodiment of the present invention will be described with reference to FIG. 4.

FIG. 4 is a diagram illustrating an implementation example of a method for parallel processing flow based data according to an embodiment of the present invention.

In operation 401, the parallel processing apparatus 100 may receive data including an Internet Protocol (IP) packet.

The input IP packet may include layers 2 to 7 and may also include layer 1 and a frame field of a layer based on a transfer scheme.

In the following, for ease of understanding, it is assumed that an Ethernet based frame is input. For example, the IP packet is assumed to include data of which layers 2 to 7 are to be processed.

The parallel processing apparatus 100 may require processing of layers 2 to 7 when an encryption process is required for the input IP packet, and may require processing of layers 2 to 4 when a switching and routing process is required for an input packet.

When the input IP packet includes a packet requiring processing of layers 2 to 4 and a packet requiring processing of layers 2 to 7, the parallel processing apparatus 100 may require multilayer processing.

In operation 402, the parallel processing apparatus 100 may generate a first flow based on information about layers 2 to 4 of the input data.

The input IP packet may be data requiring layer processing. Thus, when generating a flow using layer information as above, parallel processing may be enabled in a multi-core processor, thereby enhancing the packet processing performance.

In operation 403, the parallel processing apparatus 100 may classify the first flow.

To more accurately classify data, the parallel processing apparatus 100 may classify the first flow using a large amount of information among information about layers 2 to 7.

The parallel processing apparatus 100 may perform parallel processing of data using a multi-core, and may also perform parallel processing with respect to classification of the first flow, thereby enhancing the classification processing performance.

The parallel processing apparatus 100 may assign, to a predetermined idle processor core, different types of flows that are sequentially input.

When the same type of flow is being executed in a predetermined processor core, the parallel processing apparatus 100 may wait until the execution of the flow is terminated and then assign the corresponding flow to the same processor core.

When the number of generated flows is greater than the number of cores included in the multi-core and types of flows are uniformly distributed, a parallel processing rate may increase, thereby enhancing the flow processing performance.

In operation 404, the parallel processing apparatus 100 may analyze the first flow and thereby determine whether processing of information about layers 4 to 7 is required.

With respect to a process of determining whether processing of upper layer information is required, the parallel processing apparatus 100 may perform parallel processing based on the first flow.

For example, the parallel processing apparatus 100 may determine whether a deep packet inspection (DPI) is required with respect to the first flow.

When processing of information about layers 4 to 7 is not required, the parallel processing apparatus 100 may process information about layers 2 to 4 based on a first flow unit in operation 405.

The parallel processing apparatus 100 may perform parallel processing of information about layers 2 to 4 based on the first flow.

In operation 406, the parallel processing apparatus 100 may output the processed first flow.

On the contrary, when processing of information about layers 4 to 7 is required, the parallel processing apparatus 100 may regenerate the second flow based on information about layers 4 to 7 in operation 407.

According to an aspect of the present invention, a data field of layers 2 to 4 may be different from a data field of layers 4 to 7 and thus, layers required to generate a flow of determining a parallel processing rate may be different from each other.

To perform parallel processing of information about layers 4 to 7, the processing of information about layers 4 to 7, the parallel processing apparatus 100 may regenerate the second flow using the data field of layers 4 to 7 so that parallelism may be optimized in processing of information about layers 4 to 7.

In operation 408, the parallel processing apparatus 100 may process the second flow.

According to an aspect of the present invention, the parallel processing apparatus 100 may process information based on the second flow by employing a parallel processing method using a multi-core processor in order to enhance a processing rate of information about layers 4 to 7.

The parallel processing apparatus 100 may assign, to a predetermined idle processor core, different flows among second flows that are generated based on information about layers 4 to 7.

When the same type of second flow as a flow input into a processor core is being executed in a predetermined processor core, the parallel processing apparatus 100 may wait until the execution of the second flow is terminated and then assign the corresponding flow to the same processor core.

When the number of generated second flows is greater than the number of cores included in the multi-core and types of flows are uniformly distributed, a parallel processing rate may increase, thereby enhancing the processing performance of information about layers 4 to 7.

In operation 409, the parallel processing apparatus 100 may analyze the processed second flow and thereby determine whether processing of information about layers 2 to 4 is required.

The parallel processing apparatus 100 may perform parallel processing with respect to operation 409.

In operation 410, the parallel processing apparatus 100 may select a flow not requiring processing of information about layers 2 to 4 and output the selected flow.

In operation 411, the parallel processing apparatus 100 may select a flow requiring processing of information about layers 2 to 4 and process information about layers 2 to 4 in association with the first flow and the second flow.

In operation 411, the parallel processing apparatus 100 may process information about layers 2 to 4 by applying the processing result of operation 308. The parallel processing apparatus 100 may perform parallel processing with respect to operation 411.

In operation 412, the parallel processing apparatus 100 may output the processed first flow or second flow.

According to an embodiment of the present invention, it is possible to perform hierarchical parallel processing of data having a multilayer structure.

Also, according to an embodiment of the present invention, it is possible to enhance a parallel processing rate in a multiprocessor.

Also, according to an embodiment of the present invention, it is possible to classify layers having different attributes and to perform parallel processing, thereby solving a locality issue that may occur due to parallel processing.

Also, according to an embodiment of the present invention, it is possible to configure a multiprocessor in a scalable manner based on a function and a performance.

Also, according to an embodiment of the present invention, it is possible to efficiently control power consumption by hierarchically computing a function and a performance.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for parallel processing flow based data, the apparatus comprising:
an input unit to receive data;
a data classifier to classify the data into lower layer information and upper layer information;
a flow generator to generate a first flow and a second flow using the lower layer information or the upper layer information;
a determining unit to determine whether processing of the lower layer information or the upper layer information is required by analyzing the first flow or the second flow;
a processing unit to process the lower layer information or the upper layer information using a flow unit, based on the determination result; and
an output unit to output a processed flow.

2. The apparatus of claim 1, wherein the flow generator generates the first flow based on the lower layer information.

3. The apparatus of claim 2, further comprising:
a flow classifier to classify the first flow using a portion of or all of the lower layer information or the upper layer information.

4. The apparatus of claim 3, wherein the determining unit analyzes the classified first flow to determine whether processing of the upper layer information is required.

5. The apparatus of claim 4, wherein when processing of the upper layer information is not required as the determination result, the processing unit processes the lower layer information based on a first flow unit, and the output unit outputs the processed first flow.

6. The apparatus of claim 4, wherein when processing of the upper layer information is required as the determination result, the flow generator generates the second flow based on the upper layer information, and the processing unit processes the upper layer information based on a second flow unit.

7. The apparatus of claim 6, wherein the determining unit analyzes the processed second flow to determine whether processing of the lower layer information is required.

8. The apparatus of claim 7, wherein when processing of the lower layer information is not required as the determination result, the output unit outputs the processed second flow.

9. The apparatus of claim 7, wherein when processing of the lower layer information is required as the determination result, the processing unit processes the lower layer information in association with the first flow and the second flow, and the output unit outputs the first flow of the lower layer information that is processed in association with the first flow and the second flow.

10. A method for parallel processing flow based data, the method comprising:
receiving data;
classifying the data into lower layer information and upper layer information;
generating a first flow and a second flow using the lower layer information or the upper layer information;
determining whether processing of the lower layer information or the upper layer information is required by analyzing the first flow or the second flow;
processing the lower layer information or the upper layer information using a flow unit, based on the determination result; and
outputting a processed flow.

11. The method of claim 10, wherein the generating comprises generating the first flow based on the lower layer information.

12. The method of claim 11, further comprising:
classifying the first flow using a portion of or all of the lower layer information or the upper layer information.

13. The method of claim 12, wherein the determining comprises analyzing the classified first flow to determine whether processing of the upper layer information is required.

14. The method of claim 13, wherein when processing of the upper layer information is not required as the determination result, the processing comprises processing the lower layer information based on a first flow unit, and the outputting comprises outputting the processed first flow.

15. The method of claim 13, wherein when processing of the upper layer information is required as the determination result, the generating comprises generating the second flow based on the upper layer information, and the processing comprises processing the upper layer information based on a second flow unit.

16. The method of claim 15, wherein the determining comprises analyzing the processed second flow to determine whether processing of the lower layer information is required.

17. The method of claim 16, wherein when processing of the lower layer information is not required as the determination result, the outputting comprises outputting the processed second flow.

18. The method of claim 16, wherein when processing of the lower layer information is required as the determination result, the processing comprises processing the lower layer information in association with the first flow and the second flow, and the outputting comprises outputting the first flow of the lower layer information that is processed in association with the first flow and the second flow.
